(19) United States
(12) Patent Application Publication
(10) Pub. No.: US 2022/0349134 A1
(43) Pub. Date: Nov. 3, 2022

(54) DOUBLE-SIDED NOISE BARRIER SUITABLE FOR GROUND RUN-UP ENCLOSURES

(71) Applicant: VALIS- ENGENHARIA E INOVAÇÃO, S.A., CALDAS DA RAINHA, (PT)

(72) Inventor: Vasco Maria MARQUES LITO VELEZ GRILO, CALDAS DA RAINHA, (PT)

(21) Appl. No.: 17/439,414

(22) PCT Filed: Mar. 15, 2019
(86) PCT No.: PCT/PT2019/050005

§ 371 Date: Sep. 15, 2021

(51) Int. Cl. E01F 8/00; B64F 1/26

(52) U.S. Cl. CPC E01F 8/007; B64F 1/26

(57) ABSTRACT

The present invention falls within the scope of soundproofing structures for aircrafts, disclosing a double-sided noise barrier suitable for ground run-up enclosures. Therefore, it is proposed a support structure formed by two side surfaces, each side surface having sound insulating plates mounted thereon, providing a 360° soundproofing space around it. By means of the technical advantageous provided with the use of a double-sided noise barrier, the present invention discloses GRE structures which incorporates such barrier, that enable optimization of space in the assembly of a set of individual GREs.

### FIELD OF THE INVENTION

The present invention falls within the scope of soundproofing structures for aircrafts, typically existing in airports or in any infrastructures for aircrafts. In order to adequately test and service an aircraft, the latter is required to undergo specific procedures which generate high noise in its vicinity.

Therefore, soundproofing structures based on noise barriers are used for this purpose, surrounding the aircraft, and typically leaving an open area for entry and exit of the same.

During aircraft engine testing the aircraft should preferably always face the wind, i.e., operate with headwinds. This requirement means that in certain cases two or more testing structures may be required at an airport.

It is the intention of the present invention to describe a double-sided noise barrier for providing acoustic insulation, and an expandable and modular infrastructure that incorporates it, which allows the optimization of the space occupied by such infrastructure in the view of minimizing the space allowance needed for the test site.

### PRIOR ART

The background of this invention is closely related to the noise barriers available on the market, which are typically U-shaped, protecting the surrounding areas from the noise generated by the engines of the aircraft to be tested. This U-shaped configuration means a structure with three barriers, i.e. two side barriers and one back barrier, wherein at least part of the two side barriers are parallel, including their ends which are not attached to the back barrier.

The patent application U.S. Pat. No. 6,016,888 is a clear example of this technology, presenting barriers that are intended for insulating the noise generated by an aircraft and, in the particular case of this application, showing improvements as regards the stability of airflows within the structure under conditions of irregular winds.

However, the state of the art is silent in relation to the problem of the space occupied by said structures within the area defined for the execution of tests in an airport for example, and not disclosing particular configurations for such structures that aims a space optimization and, at the same time, maximizing the noise reduction possible with alternative testing locations.

### SOLVED TECHNICAL PROBLEMS

This invention was aimed at solving the problem associated with the large dimensions that soundproofing structures for testing aircrafts, such as ground run-up enclosures (GRE), normally have, which does not favour optimal use of space occupied by these structures, namely when two or more structures are required due to the wind conditions typically occurring within an airport.

### SUMMARY OF THE INVENTION

It is therefore an object of the present invention, to describe a double-sided noise barrier, suitable for use in GRE, which comprises a support structure formed by two side surfaces provided with a plurality of sound insulating plates, wherein at least one sound insulating plate is mounted in each side surface of the support structure. Such double-sided noise barrier, therefore, provides a sound absorption space ahead of each side surface of the support structure, resulting in a 360° soundproofing space around it.

It is another object of the present invention, to describe a GRE comprised by at least one double-sided noise barrier and by one jet blast deflector. Particularly, in an advantageous configuration of a GRE as described herein, it comprises one back barrier and at least one lateral barrier, wherein at least one of the barriers, i.e. at least one lateral barrier and the back barrier, is a double-sided noise barrier. In terms of structure assembly, each of the at least one lateral barrier extends in a direction and is arranged in such a way in relation to one of the ends of the back barrier, being the angle formed between a lateral barrier and a back barrier of at least 90°.

Due to the advantageous effect provided by the use of a double-sided noise barrier, it is another object of the present invention to describe a plurality of GRE structures, comprised by at least one GRE which incorporates a double-sided noise barrier.

Particularly, it is proposed a GRE structure formed by at least one GRE, wherein a free end of at least one lateral double-sided noise barrier of a GRE is associated with, preferably connected to, an end of a back barrier or of a back double-sided noise barrier. Alternatively, at least an end or at least a free end of a back double-sided noise barrier of a GRE is connected to an end of a lateral barrier.

It is also proposed a concatenated GRE structure comprised by at least two GREs, wherein the concatenated assembly of GREs is performed by associating, preferably connecting, a free end of a lateral double-sided noise barrier of a GRE with a free end of a back barrier or of a back double-sided noise barrier of another GRE.

It is therefore the use of double-sided noise barriers that provide a better mode of configuring GREs structures constituted by a plurality of GREs, in the view of optimizing the space occupied by such structures and maximizing the number of GREs to be used in a limited predefined testing site, ensuring acoustic insulation as regards the noise resulting from aircrafts therein parked.

### DESCRIPTION OF FIGURES

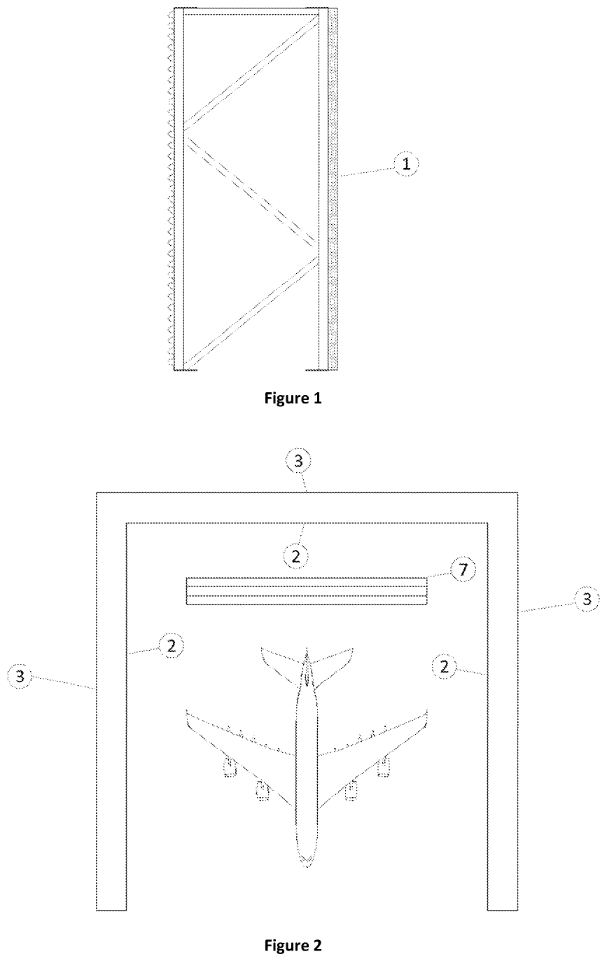

FIG. 1—representation of a state-of-the-art noise barrier which is comprised by a support structure having one noise absorbing side, where the reference signs mean:
1—noise absorbing element;
2—noise absorbing side;
6—external cladding.

FIG. 2—representation of a state-of-the art GRE comprised by three single-sided noise barriers, where the reference signs mean:
2—noise absorbing side;
3—not noise absorbing side;
7—jet blast deflector.

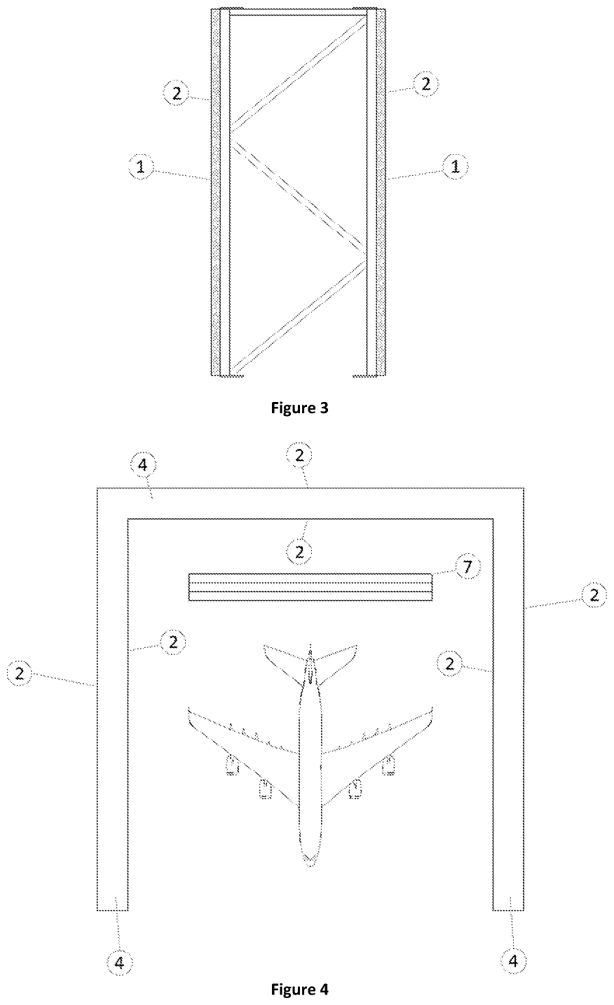

FIG. 3—representation of a double-sided noise barrier of the invention, comprised by a support structure with two noise absorbing sides, wherein the reference signs mean:
1—noise absorbing element;
2—noise absorbing side.

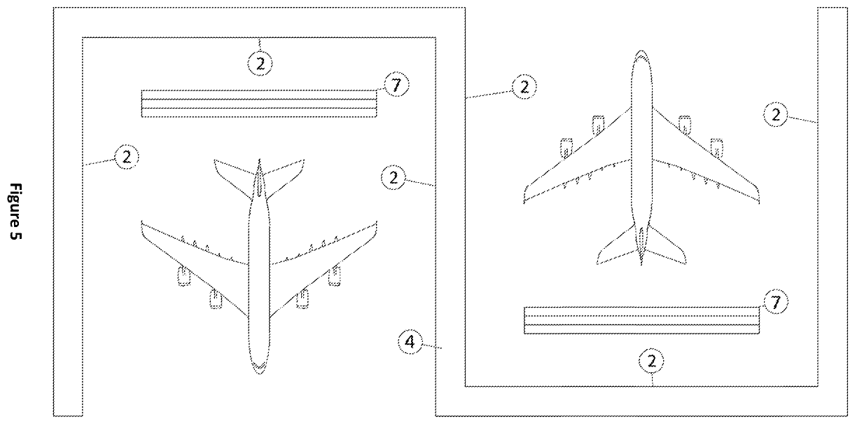

FIG. 4—representation of a GRE comprised by double-sided noise barriers, where the reference signs mean:
2—noise absorbing side;
4—double-sided noise barrier;
7—jet blast deflector.

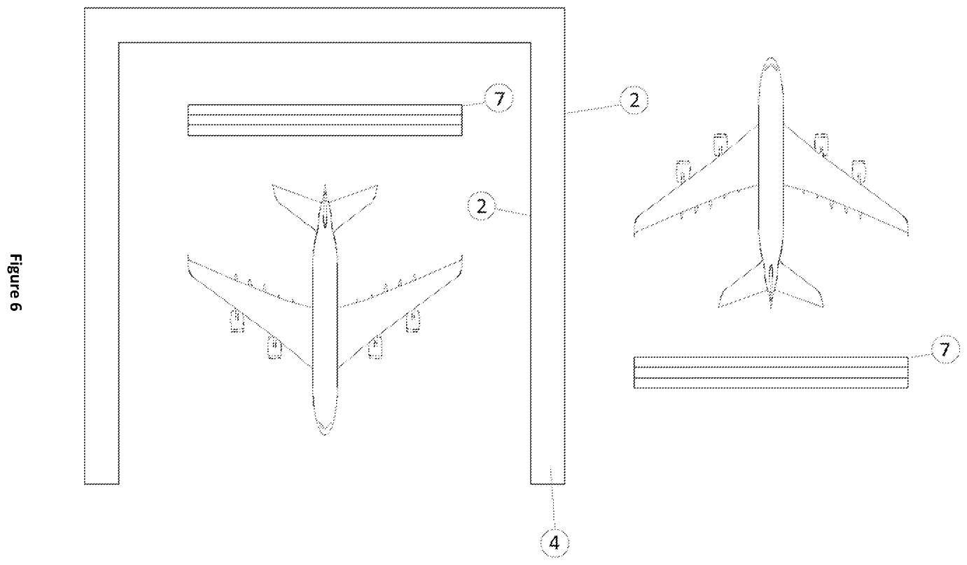

FIG. 5—representation of a concatenated GRE structure, where the reference signs means:
2—noise absorbing side;
4—double-sided noise barrier;
7—jet blast deflector.

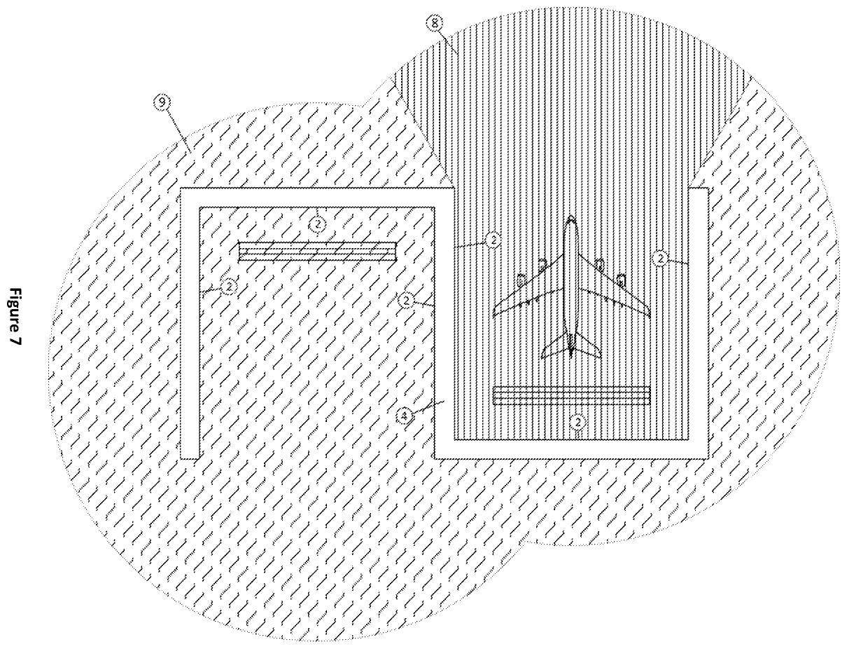

FIG. 6—representation of a GRE structure constituted by a GRE and an additional jet blast deflector, where the reference signs mean:
2—noise absorbing side;
4—double-sided noise barrier;
7—jet blast deflector.

FIG. 7—representation of the noise path in a concatenated GRE structure constituted by at least one double-sided noise barrier, where the reference signs mean:
2—noise absorbing side;
4—double-sided noise barrier;
8—noise reflection area;
9—noise shadow area.

### DETAILED DESCRIPTION

The more general and advantageous configurations of the present invention are described in the Summary of the invention. Such configurations are detailed below in accordance with other advantageous and/or preferred embodiments of implementation of the present invention.

In a preferred embodiment of the double-sided noise barrier of the present invention, it comprises a support structure formed by two side surfaces provided with a plurality of sound insulating plates. At least one sound insulating plate is mounted in each side surface of the support structure, forming a sound absorbing space ahead of each. In a particular embodiment of the double-sided noise barrier, the sound insulating plates cover the entire side surface of the support structure. In another embodiment, a sound insulating plate comprises an insulation material, preferably consisting of a noise absorbing material. Yet in another embodiment, said insulator material comprises, preferably consists of, a steel or aluminium casing with perforated surface and a noise absorbing interior made from a noise absorbing material. In another embodiment, the double-sided noise barrier comprises a steel sheet cover.

The use of a double-sided noise barrier provides a 360° soundproofing space around it, which is of utmost importance in the design of GRE structures aiming to achieve space optimization.

In connection to it, the present invention also describes a GRE comprised by at least one double-sided noise barrier and by one jet blast deflector. In a preferred embodiment of such GRE, combinable with any above embodiments of the double-sided noise barrier herein described, it comprises one back barrier and at least one lateral barrier. Each of the at least one lateral barrier extends in a direction and is arranged in such a way in relation to one of the ends of the back barrier, forming an angle of at least 90°.

At least one of the barriers, i.e. lateral barriers and back barriers, is a double-sided noise barrier. In the context of the present invention, a lateral and a back barrier which is formed by a double-sided noise barrier is defined as a lateral double-sided noise barrier and as a back double-sided noise barrier respectively. Also, in the context of the present invention, a back barrier or a lateral barrier is a single-sided noise barrier, therefore, only able to provide a 180° soundproofing space. Accordingly, a back or a lateral barrier is a support structure which comprises sound insulating plates in only one side surface of such structure. Said sound insulating plate comprises an insulator material, and preferably are consisted of a noise absorbing material. In one embodiment, the insulator material of a barrier comprises, preferably consists of, a steel or aluminium casing with a perforated surface and a noise absorbing interior made from a noise absorbing material.

In a preferred embodiment of the GRE, it is comprised by one lateral double-sided noise barrier, one lateral barrier and one back barrier. In an alternative embodiment, the GRE is comprised by two lateral barriers and one back double-sided noise barrier. In another alternative embodiment, the GRE comprises two lateral double-sided noise barriers and one back double-sided noise barrier. The angle formed between lateral barriers or lateral double-sided noise barriers and a back barrier or a back double-sided noise barrier are equal, and the angle between a lateral and a back barrier, of a single or double-sided type, is within the range of from 95 to 130°.

In what concerns to the jet blast deflector, it is structurally disposed in the space immediately in front of a back barrier or of a back double-sided noise barrier. By immediately in front, it is to be understood that there is a minimum configurable space between the deflector and the barrier.

Respecting the main objective of the present invention, related to maximizing the number of GREs and optimizing the space occupied by each structure, it is disclosed a plurality of GRE structures, which are comprised by at least one GRE composed by at least on double-sided noise barrier. By means of the technical advantageous provided with the use of a double-sided noise barrier, which offers a 360° soundproofing space around its support structure, it is possible to develop GRE structures that enable optimization of space in the assembly of a set of individual GREs.

In this regard, in a preferred embodiment, the GRE structure is comprised by at least one GRE. Particularly, a free end of at least one lateral double-sided noise barrier of a GRE is associated with, preferably connected to, an end of a new back barrier or of a new back double-sided noise barrier. Alternatively, at least an end or at least a free end of a new back double-sided noise barrier of a GRE is associated with, preferably connected to, an end of a new lateral barrier. In this context, an additional jet blast deflector can be structurally disposed in the space immediately in front of a new back barrier or in front of at least one of the sides of a new back double-sided noise barrier.

In another preferred embodiment, it is proposed a concatenated GRE structure comprised by at least two GREs, wherein the concatenated assembly of GREs is performed by associating, preferably connecting, a free end of a lateral double-sided noise barrier of a GRE with an end or with a free end of a back barrier or of a back double-sided noise barrier of another GRE.

In another preferred embodiment, it is proposed a GRE structure comprised by at least one GRE, wherein at least one additional jet blast deflector can be structurally disposed laterally in relation to each lateral double-sided noise barrier of a GRE. In that way, and contrary to the embodiments referred above, the additional blast deflectors are not associated to any single or double-sided back barriers, being positioned in such a way to take advantage of the 180° soundproofing space provided by each lateral double-sided noise barrier of the GRE and not having any back barrier—single or double-sided—behind it.

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

1. A double-sided noise barrier suitable for ground run-up enclosures characterized by comprising a support structure formed by two side surfaces provided with a plurality of sound insulating plates; wherein at least one sound insulating plate is mounted in each side surface of the support structure, forming a sound absorbing space ahead of each.

2. The double-sided noise barrier according to claim 1, wherein the sound insulating plates cover the entire side surfaces of the support structure.

3. The double-sided noise barrier according to claim 1, wherein the sound insulating plate comprises an insulator material, preferably consisting of a noise absorbing material.

4. The double-sided noise barrier according to claim 3, wherein the insulator material comprises, preferably consists of, a steel or aluminium casing with a perforated surface and a noise absorbing interior made from a noise absorbing material.

5. The double-sided noise barrier according to claim 1 comprising a steel sheet cover.

6. A ground run-up enclosure comprising at least one double-sided noise barrier according to claim 1 and one jet blast deflector.

7. The ground run-up enclosure according to claim 6, comprising one back barrier and at least one lateral barrier, each of the at least one lateral barrier extending in a direction and arranged in such a way in relation to one of the ends of the back barrier; the angle formed between the lateral barrier and the back barrier is at least 90°; and wherein at least one of the barriers is a double-sided noise barrier.

8. The ground run-up enclosure according to claim 7, comprising one lateral double-sided noise barrier, one lateral barrier and one back barrier.

9. The ground run-up enclosure according to claim 7, comprising two lateral barriers and one back double-sided noise barrier.

10. The ground run-up enclosure according to claim 7, comprising two lateral double-sided noise barriers and one back double-sided noise barrier.

11. The ground run-up enclosure according to claim 8, wherein the angle formed between lateral barriers or lateral double-sided noise barriers and a back barrier are equal.

12. The ground run-up enclosure according to claim 7, wherein the angle formed between a lateral barrier or a lateral double-sided noise barrier and a back barrier or a back double-sided noise barrier is within the range of from 95 to 130°.

13. The ground run-up enclosure according to claim 6, comprising one bad barrier and at least one lateral barrier, each of the at least one lateral barrier extending in a direction and arranged in such a way in relation to one of the ends of the back barrier; the angle formed between the lateral barrier and the back barrier is at lean 90°; wherein the lateral barriers and the back barriers are single-sided noise barriers, comprising sound insulating plates in only one side surface of its support structure, and wherein the sound insulating plate comprises an insulator material, preferably, consisting of a noise absorbing material.

14. The ground run-up enclosure according to claim 15, wherein the insulator material of a back barrier and of a lateral barrier comprises, preferably consists of, a steel or aluminium casing with a perforated surface and a noise absorbing interior made from a noise absorbing material.

15. The ground run-up enclosure according to claim 6, wherein the jet blast deflector is structurally disposed in the space immediately in front of a back barrier or of a back double-sided noise barrier.

16. A GRE structure comprised by at least one GRE of claim 7, wherein:
a free end of at least one lateral double-sided noise barrier of a GRE is associated with, preferably connected to, an end of a new back barrier or of a new back double-sided noise barrier; or
at least an end or at least a free end of a back double-sided noise barrier of a GRE is associated with, preferably connected to, an end of a new lateral barrier.

17. A GRE structure according to claim 16, wherein an additional jet blast deflector is structurally disposed in the space immediately in front of a new back barrier or in front of at least one of the sides of a new back double-sided noise barrier.

18. A GRE structure comprised by at least one GRE of claim 7, wherein at least one additional jet blast deflector is structurally disposed laterally in relation to each lateral double-sided noise barrier of a GRE, and not having any back barrier or back double-sided noise barrier arranged behind it.

19. A concatenated GRE structure comprised by at least two GREs of claim 7, wherein the concatenated assembly of GREs is performed by associating, preferably connecting, a free end of a lateral double-sided noise barrier of a GRE with an end or a free end of a back barrier or of a back double-sided noise barrier of another GRE.

20. Use of the double-sided noise barrier of claim 1 in a ground run-up enclosure.

21. The ground run-up enclosure according to claim 9, wherein the angle formed between lateral barriers and the back double-sided noise barrier are equal.

22. The ground run-up enclosure according to claim 10, wherein the angle formed between lateral double-sided noise barriers and the back double-sided noise barrier are equal.
